(19) United States
(12) Patent Application Publication
(10) Pub. No.: US 2020/0315171 A1
(43) Pub. Date: Oct. 8, 2020

(54) PSYLLID PHEROMONE COMPOSITIONS

(71) Applicants: The Regents of the University of California, Oakland, CA (US); Fundecitrus, Araraquaran (BR)

(72) Inventors: Walter S. LEAL, Davis, CA (US); Odimar Z. ZANARDI, Piracicaba-SP (BR); Haroldo X.L. VOLPE, Piracicaba-SP (BR); Marcelo P. MIRANDA, Piracicaba-SP (BR); Rodrigo F. MAGNANI, Piracicaba-SP (BR); Arodi P. FAVARIS, Piracicaba-SP (BR); Jose Mauricio S. BENTO, Piracicaba-SP (BR); Weliton D. SILVA, Piracicaba-SP (BR); Jose Roberto P. PARRA, Piracicaba-SP (BR)

(21) Appl. No.: 16/768,551

(22) PCT Filed: Nov. 30, 2018
(86) PCT No.: PCT/US2018/063445

§ 371 Date: May 29, 2020

Related U.S. Application Data
(60) Provisional application No. 62/593,782, filed on Dec. 1, 2017.

(51) Int. Cl. A01N 37/02; A01M 1/02

(52) U.S. Cl. CPC A01N 37/02; A01M 1/023

(57) ABSTRACT

The present invention provides insect lure traps and pheromone dispensers useful in controlling and monitoring psyllid insects. The insect lure traps and pheromone dispensers comprise C1-C5 carboxylic acid, such as formic acid, acetic acid, and propionic acid.

### CROSS-REFERENCES TO RELATED APPLICATIONS

This application claims priority to U.S. Provisional Patent Application No. 62/593,782, filed Dec. 1, 2017, which application is incorporated herein by reference in its entirety for all purposes.

### BACKGROUND OF THE INVENTION

The Huanglongbing (HLB), also known as citrus greening, is one of the most devastating problems in agriculture worldwide, particularly for the citrus industry¹ given that, once infected, trees must be eradicated. In Brazil, as many as 46.2 million citrus trees (representing 26% of the currently planted trees) have been eradicated since the detection of HLB in 2004². In Florida, HLB has caused severe losses to the citrus industry. Because of HLB and hurricane Irma, this year's production is forecast to be 68.7 million boxes of oranges, as compared to 96.9 million boxes produced in 2014-2015³.

HLB is caused by endogenous, phloem-restricted bacteria of the genus ‘Candidatus Liberibacter spp.’, which are transmitted from tree to tree by the Asian citrus psyllid, Diaphorina citri Kuwayama (Hemiptera: Liviidae) in Asia and America and the African citrus psyllid, Trioza erytreae (Del Guercio) (Hemiptera: Triozidae) in Africa¹. Two other psyllid species have been implicated without actual transmission tests⁴. Thus, the Asian citrus psyllid (ACP), which led to HLB being widespread in China, Brazil, and the United States⁴, is today's most serious threat to the citrus industry. In places like Arizona and California where ACP is present, but the disease apparently has not been established, the emphasis is on early detection, eradication, and limiting the spread of the disease⁴, whereas in other areas like in Florida, where HLB is widespread⁴, monitoring ACP populations is essential to avoid reinfection after eradication of infected plants.

Currently, colored sticky traps are widely used for D. citri detection and population monitoring in field studies⁵. Efficient lures are sorely needed for sticky traps, particularly for early ACP detection; otherwise, farmers have to resort to regular sprays to avoid infection given that infected insects from gardens and noncommercial areas migrate to citrus farms⁶. Pheromones and other semiochemicals have been widely used in agriculture and medical entomology as lures in trapping systems for monitoring and surveillance⁷, as well as strategies for controlling populations, such as mating disruption⁸ and attraction-and-kill systems⁹.

Although the superfamily Psylloidea includes more than 3800 described species, males of only 4 species have been shown to be attracted to “pheromones” produced by conspecific females¹⁰, specifically males from Cacopsylla bidens, C. pyricola¹¹, Bactericera cockerelli¹², and D. citri¹³. Subsequently, Mann et al. identified cuticular hydrocarbons from D. citri females, which were attractive to conspecific males in laboratory assays, but did not increase total trap catches as compared to blank traps under field conditions¹⁴. Hitherto, ACP pheromones remain elusive, most probably because ACP's complex behavior and biology have confounded isolation of the active semiochemicals. These confounding factors include acoustic communication,¹⁵ the unusual observation that mated females appear more attractive than virgin females¹³, influence of the female abdomen color on male attraction¹⁶, and the intriguing report that male attraction to female odor significantly increased after mating experience¹⁷.

We aimed at the identification of ACP-derived semiochemicals for possible applications as trap lures, but given the scenario in the current literature and due to possible geographical variations, we decided to start from scratch by establishing a laboratory colony of ACP with insects collected on orange jasmine (Brazilian common name, murta), Murraya paniculata, in São Paulo, Brazil, studying its basic biology and behavior, attempting to isolate and identify sex-specific or sex-enriched semiochemicals, and testing them under laboratory and field conditions. Here, we report on the identification of an ACP sex pheromone, which was initially detected while testing another putative sex pheromone under field conditions.

### BRIEF SUMMARY OF THE INVENTION

The present invention provides an insect lure trap comprising a pheromone composition comprising one or more C1-C5 carboxylic acid compounds. In some embodiments, the one or more C1-C5 carboxylic acid compounds is selected from formic acid, acetic acid, propionic acid, and mixtures thereof. In some embodiments, the insect lure trap comprises a pheromone composition comprising one or more C1-C5 carboxylic acid compounds and at least one insecticide.

In some embodiments, the present invention provides a method for attracting an insect pest, comprising: placing at a target locus an insect lure trap comprising a pheromone composition comprising one or more C1-C5 carboxylic acid compounds, wherein the target locus is in effective proximity to the insect pest, thereby attracting the insect pest to the insect lure trap. In some embodiments, the one or more C1-C5 carboxylic acid compounds is selected from formic acid, acetic acid, propionic acid, mixtures thereof. In some embodiments, the insect lure trap further comprises at least one insecticide, and the method for attracting an insect pest further comprises bringing into contact the insect pest with the at least one insecticide of the insect trap, thereby killing the insect pest. In some embodiments, the insect pest is a citrus psyllid. In some embodiments, the citrus psyllid is an Asian citrus psyllid. In other embodiments, the citrus psyllid is an African citrus psyllid.

In some embodiments, the present invention provides a pheromone dispenser for disrupting mating of an insect pest comprising a pheromone composition comprising one or more C1-C5 carboxylic acid compounds. In some embodiments, the one or more C1-C5 carboxylic acid compounds of the pheromone dispenser for disrupting mating of an insect pest is selected from formic acid, acetic acid, propionic acid, and mixtures thereof.

In some embodiments, the present invention provides a method of disrupting mating of an insect pest, comprising: placing at a target locus a pheromone dispenser comprising a pheromone composition comprising one or more C1-C5 carboxylic acid compounds, wherein the target locus is in effective proximity to the insect pest, thereby disrupting mating of the insect pest. In some embodiments, the one or more C1-C5 carboxylic acid compounds of the pheromone dispenser is selected from the group consisting of formic acid, acetic acid, propionic acid, and mixtures thereof. In some embodiments, the insect pest is a citrus psyllid. In some embodiments, the citrus psyllid is an Asian citrus psyllid. In other embodiments, the citrus psyllid is an African citrus psyllid.

### BRIEF DESCRIPTION OF THE DRAWINGS

FIG. 1A shows age dependence on the frequency of copulation for the Asian citrus psyllid and FIG. 1B shows age dependence on the frequency of re-copulation for the Asian citrus psyllid.

FIG. 2 shows diel rhythm of mating activity for seven-day-old adult Asian citrus psyllid (ACP), showing a window of mating activity towards the end of the scotophase, with a peak corresponding to the peak of flight activity under field conditions.

FIGS. 3A-3B show behavioral responses from ACP males and females to odorants from virgin or mated males and females. FIG. 3A shows behavioral responses when males were used as odor sources (virgin, left; or mated, right). FIG. 3B shows behavioral responses when females were used as odor sources (virgin, left; or mated, right). In both cases, tested responders were virgin males (VM), mated males (MM), virgin females (VF), and mated females (MF). Control (C).

FIGS. 4A-4C show behavioral responses of 7-day-old virgin males to acetic acid (AA). FIG. 4A shows responses in a Y-olfactometer, and FIGS. 4B and 4C show responses in a 4-way olfactometer. FIGS. 4A and 4B show that males were significantly attracted to the AA side of the arena compared to the control (C) side of the arena. Males also spent significantly more time on the AA than in control area, as shown in FIG. 4C.

FIG. 5 shows results of field tests with yellow sticky traps baited with acetic acid (AA) or hexane (control). Mean number of adults captured per trap per week.

FIGS. 6A-6C show results of field tests with yellow sticky traps baited with 0.1, 1.0, and 10 μg of formic acid (FIG. 6A), with 0.1, 1.0, and 10 μg of acetic acid (FIG. 6B), and 0.01, 0.1, and 1.0 μg of propionic acid (FIG. 6C). Mean number of adults captured per trap per week.

FIGS. 7A-7C show behavioral responses of 7-day-old virgin females to acetic acid (AA). FIG. 7A shows responses in a Y-olfactometer, and FIGS. 7B and 7C show responses in a 4-way olfactometer. FIGS. 7A and 7B show that females were not significantly attracted to the AA side of the arena compared to the control (C). FIG. 7C shows that females did not spend significantly more time on the AA than in the control area.

FIG. 8 shows duration of copulation (Mean±SEM, min) according to insect age.

FIGS. 9A-9B show chromatograms from a fraction obtained after fractionating females (top) and male (bottom) whole-body extracts. FIG. 9A is a full, expanded view of the chromatogram and FIG. 9B is a zoomed-in section of the chromatogram between 23.50 and 26.50 minutes, showing a difference (indicated with an arrow) between males and females. The female-enriched peak was identified as lignoceryl acetate.

FIG. 10 shows results of quantification of the areas of the peak highlighted in FIG. 9B. Crude extracts (4 adult-equivalent) from males and females were injected (n=5) for quantification. Female extracts (left) contained significantly more lignoceryl acetate than male extracts (right).

FIGS. 11A-11F show results of field tests of yellow sticky traps baited with 1.0, 10, and 100 μg of lignoceryl acetate (24Ac) after 7 days (FIG. 11A), 14 days (FIG. 11B), 21 days (FIG. 11C), 28 days (FIG. 11D), 35 days (FIG. 11E), and 42 days (FIG. 11F). Traps were replaced weekly, but the lures were maintained for the entire duration of the experiment. Typically, experiments were terminated after a short duration showing negative results, but the extended time showed a peculiar performance after 4 weeks. Although captures in 24Ac-loaded traps were not significantly different from those in control traps until 28 days, a significant difference was observed at 35 and 42 days. Columns with the same letters are not significantly different.

FIGS. 12A-12F show results of repeated field tests of yellow sticky traps baited with 1.0, 10, and 100 μg of 24Ac after 7 days (FIG. 12A), 14 days (FIG. 12B), 21 days (FIG. 12C), 28 days (FIG. 12D), 35 days (FIG. 12E), and 42 days (FIG. 12F). Captures in 24Ac-baited traps were significantly higher than captures in control traps 35 and 42 days after the onset of the experiments, but not earlier.

FIGS. 13A-13H show results of field tests of yellow sticky traps baited with 1.0 μg of 24Ac after 7 days (FIG. 13A), 14 days (FIG. 13B), 21 days (FIG. 13C), 28 days (FIG. 13D), 35 days (FIG. 13E), 42 days (FIG. 13F), 49 days (FIG. 13G), and 52 days (FIG. 13H). Captures in 24Ac-baited traps were significantly higher than captures in control traps 35 and 42 days after the onset of the experiments, but not earlier or after that time window.

FIG. 14 shows results of field tests with transparent traps and aged lures baited with 1.0 μg of 24Ac. Captures in traps with aged lures were significantly higher than catches in control traps during the first week in the field. In the second week, captures decreased, and in the third week after being matured and deployed in the field, the lures lost activity.

FIGS. 15A-15B show chromatograms from solid-phase microextraction (SPME) analyses from ACP virgins, 7-day-old males (bottom line) and females (top line). FIG. 15A show the chromatogram of airborne volatile capture during the time corresponding to the window of mating activity. FIG. 15B show the chromatogram of similar collections obtained from males and females during the scotophase, when no mating activity takes place. An arrow highlights the peak of acetic acid.

### DETAILED DESCRIPTION OF THE INVENTION

### I. Definitions

As used herein, the term “attracting” refers to the action of causing an insect pest, either directly or indirectly, to move in a direction towards the source of stimulus. One of skill in the art will recognize that suitable stimuli include thermostimuli, mechanostimuli, for example, airborne sound waves, or substrate borne pressure waves, electromagnetic stimulus including visual stimulus such as patterns, objects, color, light, and chemical stimulus including pheromones. A chemical stimulus can be an individual compound or a composition, including more than one compound, that either directly or indirectly, causes the insect to move toward the source of the stimulus.

As used herein, the term “insect pest” refers to any insect or population of insects that is disruptive or destructive to the growth and development of agricultural crops. Examples of agricultural crops useful in the present invention include, but are not limited to, citrus plants. In some embodiments, insect pests of the present invention include citrus psyllid insects, such as Asian citrus psyllid, Diaphorina citri and the African citrus psyllid, Trioza erytreae.

As used herein, the term “isolated” refers to a substance that has been separated from one or more substances so as to obtain pure or in a free state. In some embodiments, methods of isolation include crystallization and chromatography. Other methods of isolation will be apparent to one of skill in the art.

As used herein, the term “lure trap” refers to any device into which the pheromone compositions of the present invention are placed, and that prevents the insect pest from escaping once the insect pest has come into contact with the trap. The present invention provides traps that can be of various sizes, shapes, colors, and materials. Traps of the present invention can be designed and manufactured specifically for use as an insect trap, or can be a container converted and adapted from other uses such as, for example, a glass Petri dish, a metal coffee can, a cardboard box, or any ordinary plastic, metal, fiberglass, composite or ceramic container. Preferred materials for use in making the traps of the present invention include, but are not limited to, cardboard, metal, metal alloys, glass, paper, plastic, acrylic, fiberglass, composite, and ceramic. The traps of the present invention preferably have a bottom, sidewalls, and a top. The bottom, sidewalls and top of the trap can be solid, or be perforated. An example of a perforated sidewall is a screen. The traps are configured such that insect pests can enter the trap but are unable to escape once inside the trap. In some embodiments, the lure trap includes an insecticide. Other useful traps of the present invention are commercially available.

As used herein, the term “mating disruption” refers to the release of pheromone compositions (e.g., using controlled release from polymers comprising the pheromone, or by automated aerosol dispensers) in sufficient quantities that males are unable to orient to natural sources of pheromone, fail to locate females, and reproduction is thus prevented.

As used herein, the terms “insecticide” or “pesticide” refer to any substance that may be used for controlling insect pests in all developmental forms. Insecticides include ovicides, larvicides/nymphicides, and adulticides used against the eggs, larvae/nymphs, and adults of insects, respectively. Insecticides are commonly used in agriculture, medicine, industry, and for household use. One of skill in the art will recognize which insecticides will be useful in the present invention

As used herein, the terms “control” and “controlling,” with respect to insect pests, refer to killing, eradicating, arresting in growth, inhibiting, reducing in number, and/or imparting sterility.

As used herein, the term “locus” refers to a physical location, position, area, point, or place. A target locus is a specific location, position, area, point, or place that is in effective proximity to a target insect pest population and/or agricultural crop to be protected (e.g., target area). As used herein, the term “effective proximity” refers to a distance at which pheromone compositions of the present invention (e.g. one or more C1-C5 carboxylic acid compounds) are able to attract, attract and control (e.g., kill), or disrupt mating of an insect pest (e.g., target insect pest population).

### II. Insect Lure Traps

The present invention provides an insect lure trap comprising a pheromone composition comprising one or more C1-C5 carboxylic acid compounds. An insect lure trap of the invention may comprise one, two, three, four, or five different C1-C5 carboxylic acid compounds disclosed herein. For example, an insect lure trap useful in the present invention comprises formic acid, acetic acid, propionic acid, butyric acid, pentanoic acid, or a mixture thereof. In some embodiments, the insect lure trap comprises formic acid. In some embodiments, the insect lure trap comprises acetic acid. In some embodiments, the insect lure trap comprises propionic acid.

The insect lure trap may comprise the pheromone composition emitted from vaporizers, treated mats, treated pods, absorbed material, cylinders, oils, candles, wicked apparatus, fans, within or near trap entrances. In yet other embodiments, of the insect lure trap the pheromone composition is a liquid source that can evaporate to form vapors within or near trap entrances. In other embodiments, the insect trap is suction based, light based, or electric current based.

In other embodiments, the C1-C5 carboxylic acid compound composition of the present invention is formulated in rubber septa or in disks. One of skill in the art will recognize that other formulations are useful in the present invention.

In some embodiments, the insect lure trap includes a pheromone composition comprising one or more C1-C5 carboxylic acid compounds and at least one insecticide. One of skill will recognize that a number of insecticides are useful against citrus psyllid insects. Examples include abamectin, beta-cyfluthrin, carbaryl, chlorantraniliprole, chlorpyrifos, cyantraniliprole, cyfluthrin, diflubenzuron, dimethoate, fenpropathrin, fenpyroximate, flupyradifurone, imidacloprid, narrow range oils (415, 435, and/or 440), pyrethrins, spinetoram, spinosad, spirotetramat, thiamethoxam, and zeta-cypermethrin.

### III. Methods for Attracting an Insect Pest

Insect lure traps comprising a pheromone composition of the invention (i.e., one or more C1-C5 carboxylic acid compounds) can be used to attract insect pests for the purposes of: (i) monitoring population levels of the insect pests; (ii) mass trapping the insect pests; and/or (iii) insect pest control through lure and kill techniques.

Monitoring of infestation levels is crucial in insect pest control. The insect pest can be monitored by placing traps in the target area which attract the insect pest to the trap through the use of a semiochemical (i.e., pheromone/pheromone composition). The monitoring of infestations enables decisions to be made as to if and when to apply insecticides. In order to ensure representative monitoring, the semiochemical lures have to be attractive enough to lure the target insect pest (i.e., citrus psyllids).

Mass trapping works in a similar way to monitoring, but on a much larger scale. Mass trapping has the aim of population control via trapping enough of the target insect pest population to control it and thereby reduce the damage it causes. Traps with suitable attractants are placed in the target area in much higher numbers than would be the case with monitoring where the aim is to trap and count a representative proportion of the total infestation.

Attract and kill strategies involve attracting the target insect pest using the insect lure trap. As described above, the insect lure trap will contain a pheromone composition (i.e., C1-C5 carboxylic acid) and an insecticide. The insect pest is attracted to the insect lure and when the target pest comes into contact with the insecticide, it is sterilized or killed. Lure and kill systems are heavily dependent on the attractant that brings the pest into contact with the insecticide.

The present invention also provides a method for attracting an insect pest, comprising: placing at a target locus an insect lure trap comprising a pheromone composition comprising one or more C1-C5 carboxylic acid compounds, wherein the target locus is in effective proximity to the insect pest, thereby attracting the insect pest to the insect lure trap. The method for attracting an insect pest of the present invention involves using an insect lure trap that is loaded or baited with one or more of the C1-C5 carboxylic acid compounds disclosed herein. For example, a method for attracting an insect pest useful in the present invention comprises loading an insect lure trap with one or more of the following C1-C5 carboxylic acid compounds: formic acid, acetic acid, propionic acid, butyric acid, pentanoic acid, or any suitable mixture thereof. In some embodiments, the method for attracting an insect pest comprises placing at a target locus an insect lure trap comprising a pheromone composition formic acid, acetic acid, propionic acid, or any suitable mixture thereof. In some embodiments, the method for attracting an insect pest comprises placing at a target locus an insect lure trap comprising a pheromone composition comprising formic acid. In some embodiments, the method for attracting an insect pest comprises placing at a target locus an insect lure trap comprising a pheromone composition comprising acetic acid. In some embodiments, the method for attracting an insect pest comprises placing at a target locus an insect lure trap comprising a pheromone composition comprising propionic acid.

One of skill will recognize that the manner in which the lure traps of the invention are used will depend upon the particular pest to be controlled or crop to be protected. In some embodiments, the insect pest is a hemipteran insect from the Psyllidae family, Liviidae family, or the Triozidae family. In some embodiments, the insect pest is a psyllid, such as, for example, an Asian citrus psyllid (Diaphorina citri) or an African citrus psyllid (Trioza erytreae). In some embodiments, the insect pest that is attracted to the lure trap using the methods described herein is a citrus psyllid. In another embodiment, the insect pest that is attracted to the lure trap using the methods described herein is the Asian citrus psyllid or the African citrus psyllid.

In some embodiments, the method for attracting an insect pest involves placing at a target locus an insect lure trap comprising a pheromone composition comprising one or more C1-C5 carboxylic acid compounds and at least one insecticide. In such embodiments, the insect lure trap, loaded with one or more C1-C5 carboxylic acid compounds and at least one insecticide, is placed in effective proximity to the insect pest. Once placed in the target locus, the one or more C1-C5 carboxylic acid compounds of the insect lure trap attracts the insect pest to the insect lure trap, bringing into contact the insect pest with the at least one insecticide of the insect trap, thereby killing or sterilizing the insect pest. In some embodiments, the one or more insecticide is selected from abamectin, beta-cyfluthrin, carbaryl, chlorantraniliprole, chlorpyrifos, cyantraniliprole, cyfluthrin, diflubenzuron, dimethoate, fenpropathrin, fenpyroximate, flupyradifurone, imidacloprid, narrow range oils (415, 435, and/or 440), pyrethrins, spinetoram, spinosad, spirotetramat, thiamethoxam, zeta-cypermethrin, and any suitable mixture thereof.

### IV. Methods of Disrupting Mating

The present invention also provides a pheromone dispenser for disrupting mating of an insect pest comprising a pheromone composition comprising one or more C1-C5 carboxylic acid compounds. A pheromone dispenser for disrupting mating of an insect pest may comprise one, two, three, four, or five different C1-C5 carboxylic acid compounds disclosed herein. For example, a pheromone dispenser for disrupting mating of an insect pest useful in the present invention comprises formic acid, acetic acid, propionic acid, butyric acid, pentanoic acid, or a mixture thereof. In some embodiments, the pheromone dispenser for disrupting mating of an insect pest comprises formic acid. In some embodiments, the pheromone dispenser for disrupting mating of an insect pest comprises acetic acid. In some embodiments, the pheromone dispenser for disrupting mating of an insect pest comprises propionic acid.

A number of pheromone dispenser devices that provide a pheromone reservoir and controlled release of the contents are known. For example, a common method relies upon evaporation from polymers impregnated or filled with the pheromone composition. Such devices are typically composed of rubber and plastic in sizes ranging from sprayed microcapsules to long strips hung on trees. Such devices can be open-ended hollow fibers or hollow tubes having their lumen filled with the composition and sealed at the end. In addition, automated aerosol dispensers can be used. Release of high and uniform concentrations of the pheromone or pheromone composition from pheromone dispenser devices are thought to shut down the ability of male sensory organs to detect the pheromone. In addition, if the pheromones are released from many sources, males are attracted to false sources, thereby wasting time and energy. Under these conditions, the likelihood of a male finding a female is reduced.

The present invention also provides a method for disrupting mating of an insect pest, comprising: placing at a target locus a pheromone dispenser comprising a pheromone composition comprising one or more C1-C5 carboxylic acid compounds, wherein the target locus is in effective proximity to the insect pest, thereby disrupting mating of the insect pest. The method for disrupting mating of an insect pest of the present invention involves using a pheromone dispenser that is loaded/baited or filled with one or more of the C1-C5 carboxylic acid compounds disclosed herein. For example, a method for disrupting mating of an insect pest useful in the present invention comprises loading pheromone dispenser with one or more of the following C1-C5 carboxylic acid compounds: formic acid, acetic acid, propionic acid, butyric acid, pentanoic acid, or any suitable mixture thereof. In some embodiments, the method for disrupting mating of an insect pest comprises placing at a target locus a pheromone dispenser comprising a pheromone composition comprising formic acid, acetic acid, propionic acid, or any suitable mixture thereof. In some embodiments, the method for disrupting mating of an insect pest comprises placing at a target locus a pheromone dispenser comprising a pheromone composition comprising formic acid. In some embodiments, the method for disrupting mating of an insect pest comprises placing at a target locus a pheromone dispenser comprising a pheromone composition comprising acetic acid. In some embodiments, the method for disrupting mating of an insect pest comprises placing at a target locus a pheromone dispenser comprising a pheromone composition comprising propionic acid.

One of skill will recognize that the manner in which the pheromone dispensers of the invention are used will depend upon the particular pest of which mating is to be disrupted or crop to be protected. In some embodiments, the insect pest is a hemipteran insect from the Psyllidae family, Liviidae family, or the Triozidae family. In some embodiments, the insect pest is a psyllid, such as, for example, an Asian citrus psyllid (Diaphorina citri) or an African citrus psyllid (Trioza erytreae). In some embodiments, the pheromone dispensers of the methods described herein disrupt the mating of the citrus psyllid. In another embodiment, the pheromone dispensers of the methods described herein disrupt the mating of the Asian citrus psyllid or the African citrus psyllid.

### V. Examples

### General Materials and Methods.

Insect Preparations. A laboratory ‘Ca. Liberibacter spp.’ free colony was initiated with insects collected from M. paniculata in São Paulo State, Brazil in 2009 and reared in a greenhouse under 25±5° C. For this purpose, 400 mated adults were placed in cages (60×60×60 cm) containing M. paniculata seedlings and kept for 7 days for oviposition. Then, adults were removed and the seedlings with eggs were kept in cages. Once nymphs reached the fifth instar, cages were transferred to a climate-controlled room at 25±2° C., 65±10% RH, and L14:D10 h photoperiod until adult emergence. These conditions were selected to mimic field conditions during ACP flight activity in São Paulo, Brazil. Luminosity was set at 3000 lux. Newly emerged adults were collected and separated by sex for bioassays.

Mating behavior analysis. These experiments were performed in a climate-controlled room at 25±2° C., 65±10% RH, L14:D10 h photoperiod, and 3000 lux luminosity. For this purpose, M. paniculata seedlings were pruned 5-cm height 15 days before the beginning of the experiment to allow emission of flushes. Seedlings containing flushes of −2 cm in length were allocated to plastic cages 10 cm in height×7.5 cm in diameter and used as an experimental unit. After that, one virgin D. citri male and one virgin female (couple) with 1, 2, 3, 4, 5, 6, and 7 days after emergence (treatments) were released inside the cage. For each treatment (couple age), 70 replicates were performed. The mating activity of each couple were assessed every 30 min (24 h a day) for 7 days.

Indoor behavioral assays. All behavioral assays were conducted in a climate-controlled room (see above). A glass tube in a Y-shape (central tube 15 cm in length and 3 cm in diameter split into two tubes in a 120° angle with the same dimensions used in the central tube) was placed vertically with the decision arms pointing towards the ceiling (light sources). All connections were made with 0.635-diameter polytetrafluoroethylene (PTFE) tubes (Sigma-Aldrich, Bellefonte, Pa., USA). Clean air was provided by an oil-free air compressor (Schulz MSV6, Schulz, Joinville, SC, Brazil) and humidified into milliQ water before the line was split into two separate lines, each one with an air flowmeter with a range from 0.1 to 1.0 L/min (Brooks Instrument, Hatfield, Pa. USA) to allow balanced flow of 0.4 mL/min. Treatment (e.g., acetic acid 0.01 μL/μL hexane 100 μL) and control (e.g., 100 μL hexane) were placed on cotton inside glass chambers (20 cm in length×6 cm in diameter) with one end connected to one of the airflow lines and the other end connected to one of the decision arms of the olfactometer. Each replicate was performed with one insect (7-day-old virgin male or female) being place inside the downwind arm of the arena, which was covered with a glass lid. Insects that crossed the central tube line located 5 cm from the bifurcation within the observation time of 5 min were recorded as responders. After that, 5 min were allowed for the responder insect to cross the lateral tube lines, located 5 cm from the connection with the central tube, allowing observation of the choice of odor. An olfactometer test consisted of the release of a single D. citri and the observation (from 15:00 to 18:00).

An air-flow olfactometer, also known as “4-arm olfactometer” or “4-way olfactometer” was constructed²⁹ (30.0×30.0×2.5 cm in length, width and height, respectively) with acrylic. A constant, charcoal-filtered humidified airflow 0.1 L/min was connected to each odor source, and all airflows converged through individual PTFE tubes to the center of the acrylic arena. Yellow fields were made by adding a yellow laser jet printed-paper below the bottom of the arena with the following color spaces: lightness (84.8±0.04), chroma (98.7±0.40), and hue angle (95.7±0.02) using a colorimeter Minolta CR400 (Konica Minolta Co., Osaka, Japan).³⁴ Two of the four possible arms received volatiles from acetic acid 0.01 μL/μL hexane (100 μL), whereas the other two remaining received hexane. The psyllids (virgin 7-day-old males or females) were released on the center of the arena. An olfactometer test consisted of the release of a single D. citri and the observation (from 15:00 to 18:00). As a criterion for data collection from each insect, five minutes were allowed for response (first choice). In case of response, 10 minutes were allowed to observe the time spent in each of the four odor fields.

Field Experiment 1: Evaluation of lignoceryl acetate, lygnocerol, formic acid, acetic acid, and propionic acid. These experiments were performed in an organic grove of Valencia sweet orange [Citrus sinensis (L.) Osbeck] grafted on ‘Rangpur’ lime (Citrus limonia Osbeck) with natural infestation of D. citri. For this purpose, yellow stick cards (30 cm in length×10 cm in width) with a 2 cm in diameter central hole were used to assess the attractivity of the test compounds to D. citri adults. Compounds were assessed at doses ranging from 0.01 μg to 100 μg. Hexane was used as a control. Tested compounds were incorporated into slow-release devices made of ES fiber (Ethylene-Propylene Side by Side, Chiso Co. Ltd, Japan). The experiments were designed in Latin square using 16 traps spaced 25 m from each other (4 traps per treatment). They were repeated three times over time and the number of captured ACP adults was recorded each 7 days for 49 days.

Field Experiment 2: Evaluation of aged lignoceryl acetate lures. Lures were prepared and kept in greenhouses for 28 days prior to being fixed in yellow stick cards in the field. Thus, aged lures were tested in the field starting on day 28 until 70 days after preparation of the lures. The area, experimental design, number of traps, and data collection were the same as described above.

Field Experiment 3: Evaluation of lignoceryl acetate lures using transparent traps. To avoid interference from the yellow visual cues from the stick cards, these experiments were performed with transparent acrylic traps (30 cm in length×10 cm in width) and covered with an adhesive glue film (Biostop Cola, Biocontrole, São Paulo, Brazil). The experimental design, number of traps, and data collection were the same as described above.

Statistical analyses. All statistical analyses were done with Prism 7 (GrapPad, La Jolla, Calif.). Each pair of a test and a control in indoor behavioral measurements using an Y-olfactometer or 4-way olfactometer, as well in field tests comparing only a single treatment and a control, was compared by using two-tailed, Wilcoxon matched-pairs signed rank test. Field tests with multiple comparison (different doses) were analyzed by ANOVA. Capture data were first transformed into log (x+1) and them means were analyzed by Dunnett's test as well as Tukey's test (P<0.05) by comparing the mean of each column with the mean of the control or with the mean of every other group, respectively.

Electrophysiology. Antennas were mounted, according to a published protocol²⁶, under a stereoscopic microscope (SZT, BEL Engineering, MB, Italy). Antennae were connected with glass microcapillaries pulled with a PC-10 puller (Narishige, Kanto, Japan). The glass capillaries housed 0.39 mm gold wires (Sigmund Cohn Corp, Mt. Vernon, N.Y.) and were filled with a saline solution (3.7 g NaCl, 0.175 g KCl, 0.17 g CaCl₂ in 500 mL of distilled water). Electrodes were connected to a Universal Probe, gain 10× (Syntech, Buchenbach, Germany) and connected to a 2-Chanel IDAC Acquisition Controller (Syntech). The signal was processed with Syntech software (GcEad version 4.6). Two Pasteur pipettes were used one for a flow balance and the other as a stimulus. The stimulus was loaded on a filter paper strip (40×4-mm), which was inserted in the stimulus pipette after evaporation for 1 min. Each cartridge was used only once. The antennal preparation was set at the end of an effluent flow tube, which had two lateral holes (13 cm from the antennal preparations) to accommodate the tips of the Pasteur pipettes (stimulus and flow balance). Humidified continuous flow (0.1 L/min) was generated by a CS-55 Stimulus Controller (Syntech). Flow for stimulus and balance were set at 1 L/min. Stimulus duration was set a 1 s. There was a minimal interval of 1 min between stimuli.

Chemical Analyses. In Davis, GC-MS was performed on a 5973 Network Mass Selective Detector linked to a 6890 GC Series Plus+ (Agilent Technologies, Palo Alto, Calif.). The GC was equipped with an HP-5MS capillary column (30 m×0.25 mm; 0.25 μm film; Agilent Technologies), which was operated with the following programs: 70° C. for 1 min, subsequently increased at a rate of 10° C./min to 270° C., and held at this final temperature for 10 min, i.e., 70(1)-10-270(10), and 50(4)-5-200(1)-10-270(10) for analysis of extracts and fractions. The injector was operated at 250° C. in pulsed splitless mode. MS transfer line was set at 280° C., and the MS quad and MS sources were set at 150° C. and 230° C., respectively. In Piracicaba, GC-MS was performed on a Varian CP-3800 gas chromatograph fitted with an HP5-MS capillary column (30 m×0.25 mm i.d.×0.25 μm film; J&W Scientific, Folsom, Calif.), coupled to a 4000 Ion Trap Mass Spectrometer (Varian, Calif., USA) and on a Shimadzu GCMS-QP2010 Ultra linked to a Shimadzu GC-2010 Plus (Shimadzu Corp., Kyoto, Japan) fitted with an RTx-1MS capillary column (30 m×0.25 mm i.d.×0.25 μm film; Restek Corporation, Bellefonte, Pa., USA).

Injections were operated in splitless mode with an injector temperature of 250° C. The GC ovens were programmed from 40° C. for 1 min, increased to 300° C. at 10° C./min (held for 50 min). MS transfer line, manifold, and trap were set at 300° C., 50° C., and 217° C., respectively. Quantitative analyses were done on a Shimadzu GC-2010 gas chromatograph equipped with a flame ionization detector (Shimadzu Corp., Kyoto, Japan) and fitted with an HP5-MS capillary column (30 m×0.25 mm i.d.×0.25 m film; Agilent Scientific, Santa Clara, Calif., USA). SPME analyses were done with a 50/30 divinylbenzene (DVB)/carboxen (CAR)/polydimethylsiloxane (PDMS) (Supelco, catalogue number 57328-U). Volatile compounds were collected from the headspace of the samples placed in a closed glass container with a rubber septum on the top. Both laboratories used the same oven temperature program, i.e., starting at 35° C. for 5 min, raising to 70° C. at a rate of 2.5° C./min, then increasing to 150° C. at 5° C./min, and subsequently raising to the final temperature of 250° C. at 20° C./min.

Airborne Volatile Collections, Crude Extracts, and Fractionations. Airborne volatile collections were done in all-glass chambers by passing clean air (as described above), trapping volatile compounds on Tenax TA (30-60 mesh, Sigma-Aldrich), and extracting them with hexane or pentane. Whole body extractions were obtained by washing with hexane for 3 min batches of 1,000-5,000 males and females. The solvent was then transferred to a clean vial, a small aliquot of hexane was added, the solvent transferred, and the last step was repeated one more time. The combined volume of the three washes was adjusted to generate male and female extracts with equal number of insect-equivalents per volume (typically 1 or 4 insect-equivalents per L). Crude extracts (3,000 female- or 3,000 male-equivalents) were subjected to flash column chromatography on silica gel (60-200 mesh; Fisher Scientific, Pittsburgh, Pa., US) by successively eluting with hexane-ether mixtures in the following order: 100:0 (hexane fraction), 95:5 (5% fraction), 80:20, 50:50, 0:100 (ether fraction). Crude extracts and fractions were analyzed by GC and GC-MS for comparison of male and female profiles.

Chemicals. Formic, acetic, propionic, butyric, valeric, and hexanoic acids, hexane, lignoceryl alcohol, acetic anhydride, pyridine, and anhydrous sodium sulfate were purchased from Sigma-Aldrich (Milwaukee, Wis.). Anhydrous dichloromethane (DCM) was acquired from ACROS (New Jersey, US). An aliquot of 11 mg of lignoceryl acetate was prepared in two batches, one starting with 10.2 mg and the other with 7 mg of lignocerol dissolved in anhydrous DCM. A pyridine/DCM solution was added stepwise; the reactions were left at room temperature for 5 h. Then, 0.5 M HCl was added, the organic phase was extracted and washed with brine, and anhydrous sodium sulfate was added. After reducing the volume by evaporation, the crude material was subjected to flash column chromatography (see above). An aliquot (1 mg) was used to make a hexane solution for GC-MS analysis and comparison of retention times. The rest of the sample was used for indoor behavioral assays and field tests in Brazil.

### Example 1: Mating Behavior

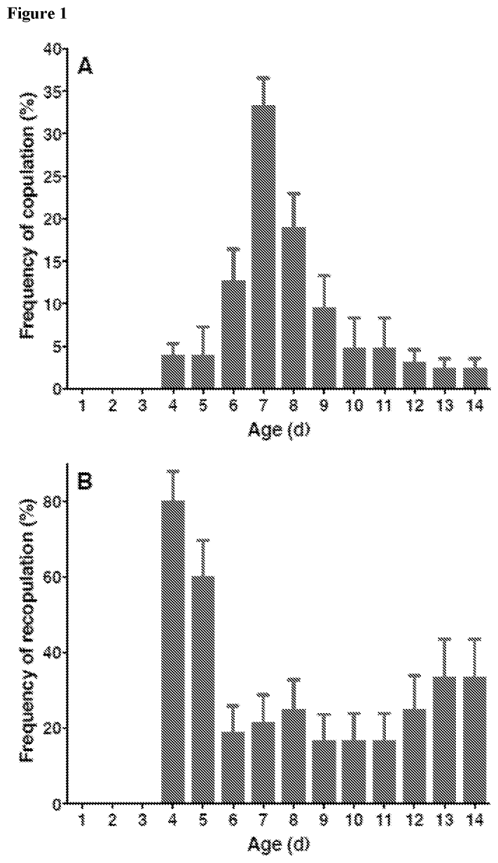

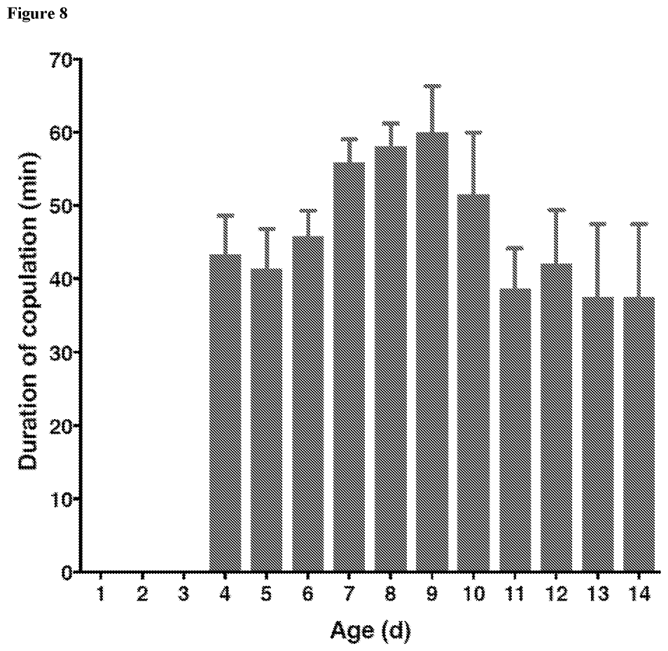

Using our laboratory colony, we studied ACP mating behavior when individual couples were kept in the laboratory on a common host, M. paniculata, and under conditions of photoperiod, luminosity, relative humidity, and temperature mimicking those found under natural conditions in most citrus fields in Brazil. As opposed to what has been observed¹⁸ with a laboratory colony originated from ACP collected in Florida in early 200019, no mating activity occurred in the first 3 days after emergence (FIG. 1A). Mating activity started 4 days after emergence, reached a clear peak with 7-day-old insects, and declined thereafter (FIG. 1A). Interestingly, couples that copulated earlier than the peak time of copulation (7 days) showed the highest frequency of re-copulation, particularly those mating 4- or 5-days after emergence (FIG. 1B). These findings suggest that earlier mating is not as efficient as mating at or after the peak of mating activity. Apparently, the frequency of re-mating was not influenced by the duration of copulation, given that mating by 4- to 14-day-old couples lasted nearly the same time (4 d, 43.3±5.27 min, mean±SEM; 5 d, 41.3±5.49 min; 6 d, 45.8±3.53 min; 7 d, 55.9±3.15 min; 8 d, 58.0±3.19 min; 9 d, 60.0±6.29 min; 10 d, 51.4±5.53 min; 11 d, 38.6±5.53 min; 12 d, 42.0±7.35 min; 13 d, 37.5±10 min; 14 d, 37.5±10 min) (FIG. 8).

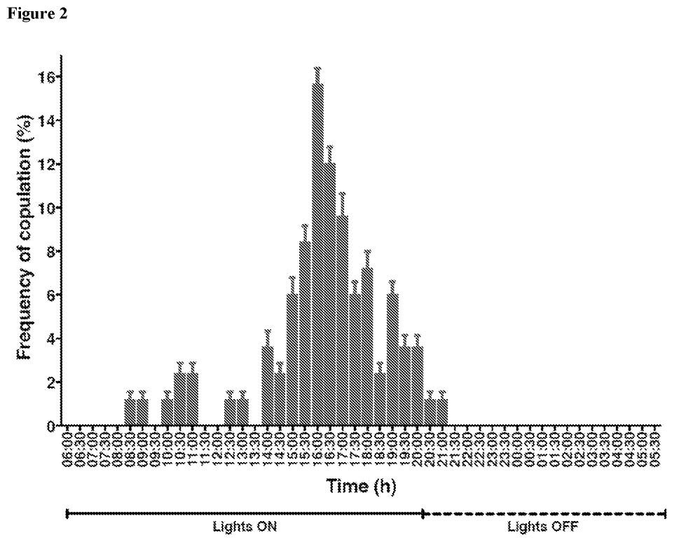

Next, we studied the diel rhythm of mating activity by 7-day-old couples. It has been reported that in a laboratory colony from Florida, mating occurs throughout daylight hours without an obvious peak of mating activity¹⁸. By contrast, we observed a clear window of activity towards the end of the photoperiod until the beginning of the photoperiod, starting at 14:00 (i.e., 8 h into the photophase) and ending at 21:00 (i.e., 1 h after the scotophase started) (FIG. 2). Of note, the reported peak of flight activity under field conditions,^{20,21} is contained within the window of mating activity observed under laboratory conditions (FIG. 2). We, therefore, used 7-day-old insects in subsequent studies and measured behavior and performed pheromone extractions during the last 6 h of the photophase.

### Example 2: Female-Produced Sex Pheromone and Male Response

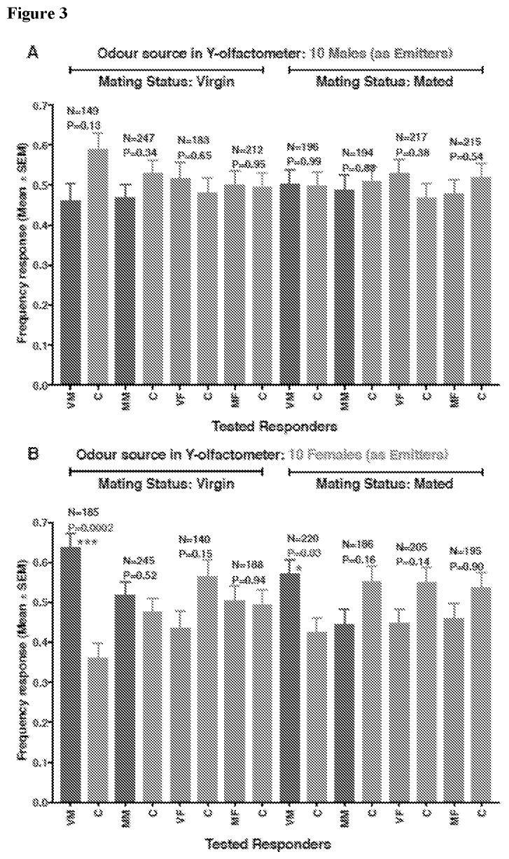

Behavioral evidence has been previously provided to demonstrate that D. citri females produce a sex-pheromone, but intriguingly it has been suggested that mated females appeared to be more attractive than virgin females³. Using an Y-olfactometer, we measured the behavioral responses of ACP males or females as responders to odor sources emitted by virgin or mated males, and virgin or mated females. We did not observe any evidence for male or female attraction when either virgin or mated males were used as odor sources (emitters) (FIG. 3A). There were no significant differences between the various treatments and their respective controls when the odor sources were virgin or mated males and the tested responders were virgin males (VM), virgin females (VF), mated males (MM), or mated females (MF). By contrast, when either virgin or mated females were used as odor sources (emitters), virgin males (VM) showed a significant preference for the treatment side of the arena, regardless of the source being virgin or mated females (FIG. 3B). However, when mated males were tested as possible responders, they did not show a significant preference for treatment vs. control when virgin or mated females were used as odor sources.

Our findings differ from those observed with a laboratory colony from Florida indicating that male attraction to female-released odorants increased after mating experience¹⁷, possibly due to the difference in experimental protocols, insect age, time of the tests, and/or possible geographical variations. In sum, under our experimental protocol considering the optimal age of test insects and timing of the bioassays (to coincide with the peak of mating activity), only VM responded to female-released odorants regardless of the emitters' mating status.

### Example 3: Attempts to Identify Constituent(S) of the Female-Released Sex Pheromone

Having confirmed that odorants released from virgin or mated females attracted virgin males (FIG. 3B), we proceeded towards the isolation and identification of the sex pheromone constituent(s). Initial attempts to extract the active ingredient(s) using airborne volatile collections were unrewarding. Behavioral measurements with airborne volatiles collected from virgin females during the time corresponding to the peak of mating activity did not show a significant preference for treatment vs. control (extracts from headspace collections, 0.51±0.07; control 0.49±0.07; n=53; P=0.91), possibly because the active ingredients were not trapped under our experimental conditions. We then changed our approach to attempt to isolate the active ingredient(s) by direct solvent extraction.

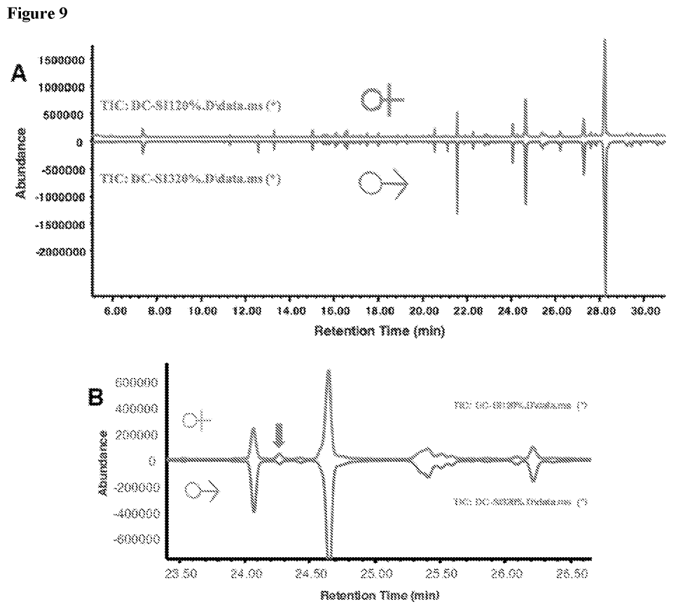

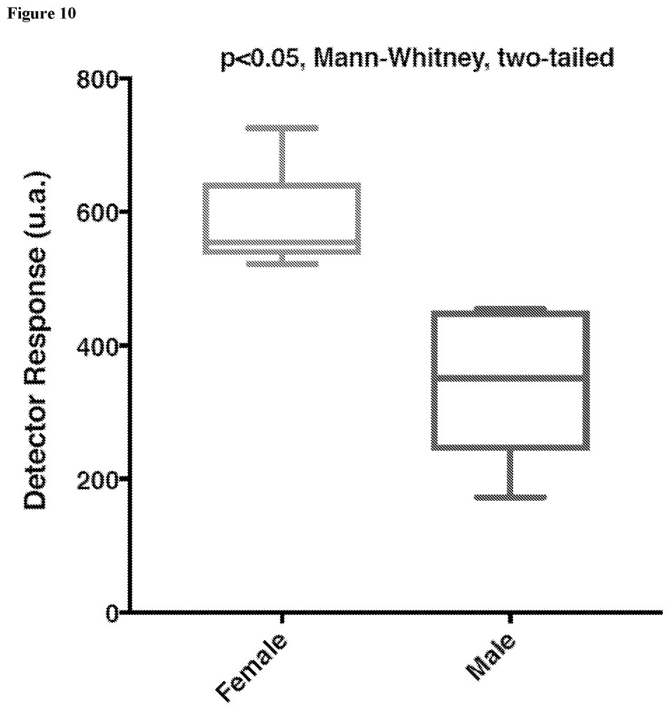

When tested in our Y-olfactometer, males responded significantly to the side arm with a hexane extract from virgin females than to the control side (solvent only) (extract, 0.59±0.04; control, 0.40±0.04, n=134; P=0.0370; Wilcoxon matched-pairs signed rank test). We then compared the GC profiles obtained from hexane extracts from males and females, but there was no evident difference between male and female traces. We fractionated the male and female extracts using silica gel columns and mixtures of hexane and dither ether, and then compared each female and male fraction. A close examination of the fractions obtained with 20% diethyl ether in hexane showed a minor peak at ca. 24.29 min, which was more intense in the female than in the male fraction (FIGS. 9A-9B). The mean area of the peaks obtained with 5 extracts from females and 5 extracts from males and by injecting on a gas chromatograph (GC) 4 insect-equivalents showed a significant difference (Female extract, 582.7±36.3 units of area (u.a.); Male extract, 347.9±51.6 u.a.; FIG. 10) and confirmed that this compound was enriched in females as compared to males.

Gas chromatography-mass spectrometry (GC-MS) analysis suggested, and comparison with authentic compound confirmed, that the female-enriched compound was tetracosyl acetate (=lignoceryl acetate). Lignoceryl acetate has been previously identified from 10 hymenopteran species, as well as a constituent of the pheromone gland of the leaf-rolling tortrix, Sparganothis pilleriana²². In chemical ecology's simplified nomenclature for pheromones, lignoceryl acetate is referred to as 24Ac so as to indicate that this semiochemical is an acetate made from a straight-chain, 24 carbon-long alcohol (lignocerol, 240H).

### Example 4: Field Evaluations of Lignoceryl Acetate-Baited Traps

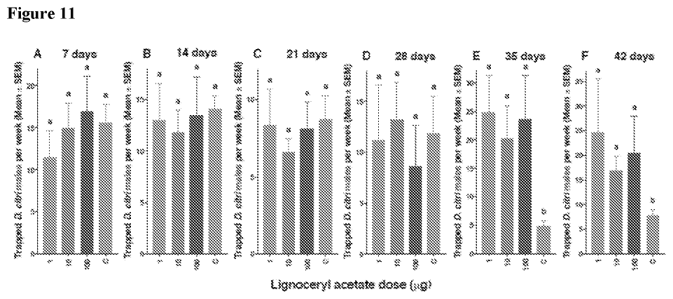

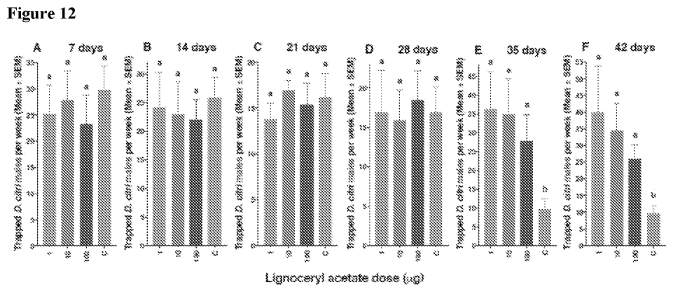

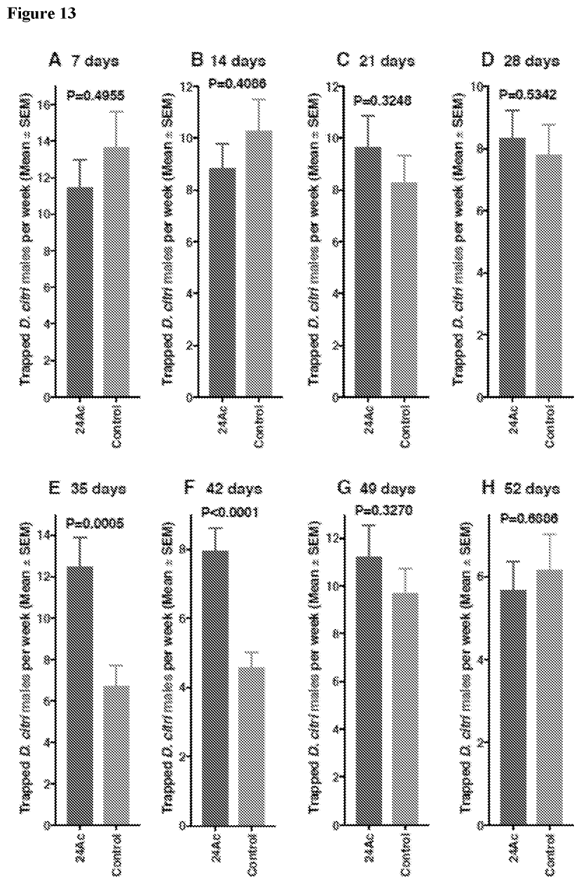

We tested in the field whether a commonly used trap to monitor ACP populations, i.e., the yellow sticky traps,^{5,23-25} baited with 24Ac at various doses would capture more ACP than control traps would capture. Although captures in traps baited with 24Ac at the doses tested (1, 10, and 100 μg per trap) in the first weeks of the experiments were not significantly different from the catches in control traps, we noticed a peculiar outcome for 24Ac-baited traps 5 weeks after traps were brought to the field (FIGS. 11A-11F). We then repeated these experiments and obtained similar and consistent results (FIGS. 12A-12F). Considering that the responses of these “old lures” were not dose-dependent (FIGS. 11A-11F & 12A-12F), we repeated these experiments with the lowest dose only, i.e., 1 μg per trap. Again, catches in 24Ac-baited traps were not different from those in control traps during the first weeks of the field tests, but significantly more males were captured in 24Ac-baited traps than in control traps at 35 and 42 days; thereafter the lures lost activity (FIGS. 13A-13H).

Behavioral measurement in our olfactometer using virgin males as responders and 24Ac as odor source, at a range of concentrations from 0.1 to 100 μg, did not show any significant preference for the treatments as compared to their respective controls (0.1 rig, n=121, P=0.2031; 1 μg, n=197, P=0.8867; 10 μg, n=152, P=0.9999; 100 μg, n=121, P=0.4671). We then surmised that, albeit chemically stable, 24Ac might undergo slow degradation under field conditions and that the active lure might be 24Ac degradation product(s). To test this assumption, we evaluated 240H in the field and did not find significant differences between treatment and controls at doses from 0.1 to 100 μg (Dunnett's multiple comparisons to control traps at each dose, each week, P=0.2770-0.9999; n=4 per dose per week). We then concluded that 240H is not an ACP attractant.

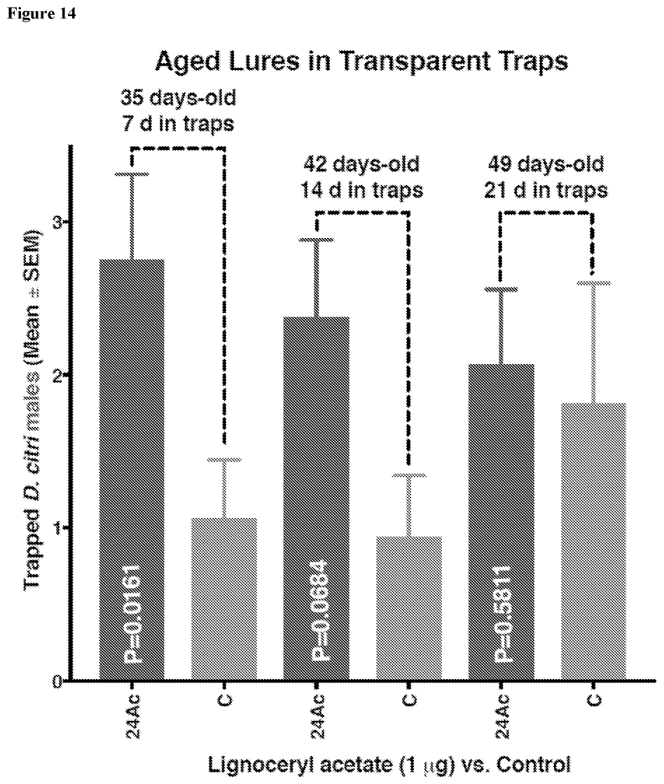

Next, we collected with solid phase microextraction (SPME) volatiles from lures matured for 5 weeks under field conditions. We detected small amounts of acetic acid in aged but not in new lures thus suggesting that 24Ac may have undergone degradation into 240H and acetic acid. We also matured lures in a greenhouse and brought them to the field after 4 weeks. To decouple the trap color factor from chemical attraction, we used in these experiments transparent traps baited with matured 24Ac lures or solvent only. Traps loaded with 24Ac lures aged for 35 days collected significantly more males than control traps collected in the first week (FIG. 14) but lost all activity after 3 weeks (FIG. 14). These findings suggest that acetic acid might be an attractant.

### Example 5: Male and Female Release of and Behavioral Responses to Acetic Acid

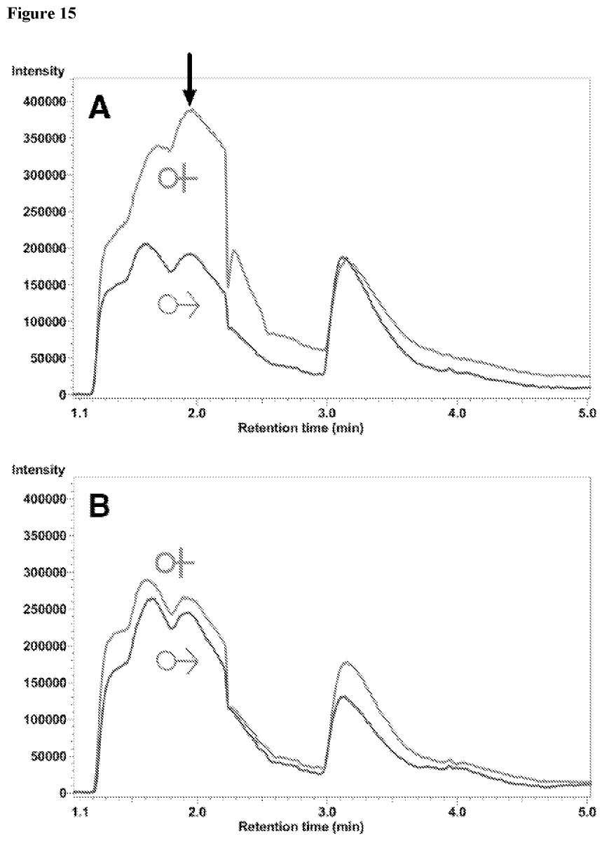

Acetic acid has been previously identified in extracts from ACP females¹⁴, but its function was not ascribed or the synthetic compound tested. SPME-based volatile collections from separated groups of 50 ACP males and females, which were removed from the host plant at least 12 h prior to the headspace collections (extracts), and subsequent GC-MS analyses showed that female extracts contained acetic acid (FIGS. 15A-15B), although trace amounts were also detected in male extracts. Recently, acetic and formic acids were identified as degradation products from plant volatile cartridges prepared for electrophysiological studies²⁶ and a tertiary blend, including these acids plus p-cymene, was demonstrated to be a phagostimulant, but not an attractant to ACP²⁷. On the other hand, acetic and propionic acids were reported to inhibit responses from olfactory receptor neurons in ACP antennae²⁸. We recorded EAG responses from ACP male and female antennae using a series of acids from 1-6 carbons. Male antennae generated robust EAG responses to acetic acid (2.70±0.36 mV, n=26) and propionic acid (2.22±0.29 mV), moderate responses to formic acid (1.60±0.63 mV), weak responses to butyric acid (0.52±0.36 mV) and valeric acid (0.24±0.03 mV), and no response to hexanoic acid when tested at a high dose (source dose, 10⁻¹).

At a lower dose (10⁻²), only acetic (1.73±0.37 mV, n=19), propionic (1.13±0.47 mV), and formic (0.42±0.37 mV) acids responded. Likewise, female antennae had stronger responses to acetic acid (source dose, 10⁻¹: 3.22±0.94 mV, n=15) than to propionic acid (2.90±1.09 mV) and formic acid (1.86±0.48 mV). In summary, both male and female antennae generate robust responses to acetic acid, low responses to formic acid, and moderate responses to propionic acid, particularly at higher doses. At very low doses (10⁻³), only male antennae responded to acetic acid (0.44±0.21 mV). Of note, there was no need to subtract background responses given that blank EAG was almost indistinguishable from the baseline. In light of these EAG results, we re-analyzed the SPME collections from male and female to determine whether other EAG-active acids were also released by ACP males and/or females. Again, acetic acid was easily detected, particularly in female airborne volatile collections at the time corresponding to the peak of mating activity.

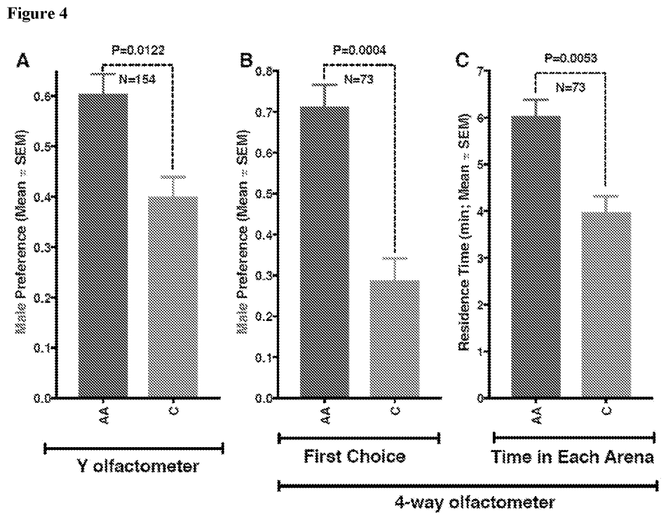

Next, we used both a Y-tube olfactometer and an air-flow olfactometer,²⁹ also known as “4-way olfactometer,” to measure ACP olfactory responses to acetic acid. Males were significantly more attracted to the acetic acid side of the Y-olfactometer than to the control side (FIG. 4A). Male preference for the acetic acid-laden fields in the 4-way olfactometer as compared to the control sides was highly significant (FIG. 4B). Additionally, males spent significantly more time in the acetic acid than in the control fields (FIG. 4C). Taken together, these behavioral measurements suggest that acetic acid is a male attractant. Considering that formic acid, acetic acid, and propionic acid were EAG active against male and female antennae, we surmised that these other carboxylic acids were also attractive and, therefore, tested them in the field.

### Example 6: Field Evaluations of Formic, Acetic, and Propionic Acid-Baited Traps

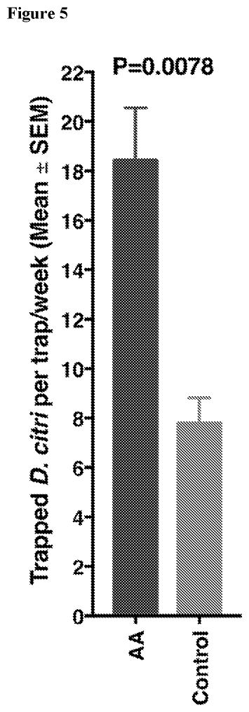

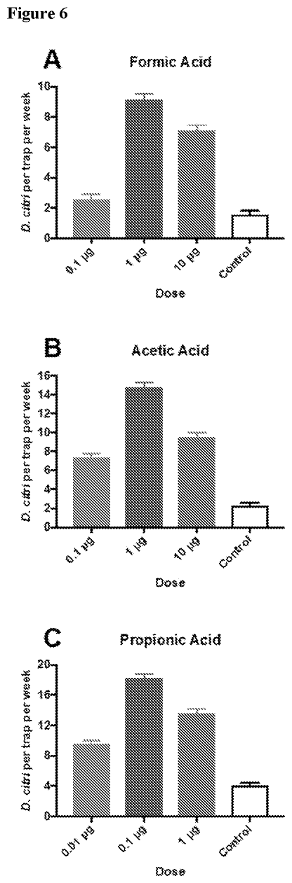

Preliminary field experiments demonstrated that traps baited with 1 ug of acetic acid captured significantly more ACP adults than control traps (FIG. 5). Traps baited with formic acid at 0.1, 1, or 10 μg captured significantly more ACP adults (2.59±0.30; 9.17±0.36; and 7.14±0.34 D. citri per trap per week, respectively) than control traps (1.54±0.26 D. citri per trap per week) (P=0.0001) (FIG. 6A). Likewise, acetic acid-baited traps (0.1, 1, or 10 μg) captured significantly more ACP adults (7.42±0.35; 14.77±0.54; and 9.52±0.50 D. citri per trap per week, respectively)] than control traps (2.31±0.28 D. citri per trap per week) (P=0.0001) (FIG. 6B). Similarly, traps baited with propionic acid (0.01, 0.1, or 1 μg) captured significantly more ACP (9.52±0.52; 18.27±0.52; and 13.79±0.53 D. citri per trap per week, respectively)] than control traps (4.06±0.33 D. citri per trap per week) (P=0.0001) (FIG. 6C). Additionally, field experiments with acetic acid at higher doses showed that control (blank) traps captured 1.48±0.22 males/trap per day, whereas traps baited with 1, 10, and 100 μg of acetic acid caught significantly (n=48 per trap; Dunnett's multiple comparisons) more insects, specifically 2.48±0.25, 3.08±0.33, and 4.23±0.35 males per trap per day (P<0.001), respectively. Taken together, these findings suggest that formic acid, acetic acid, and propionic acid are effective ACP lures.

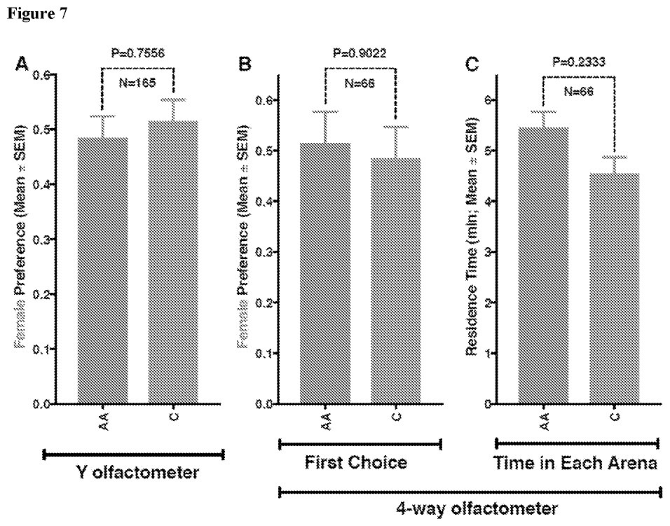

In marked contrast to what has been observed with males (FIGS. 4A-4C), response of females to the arm of the Y-olfactometer baited with acetic acid did not differ significantly from the response to the control side of the arena (FIG. 7A). Likewise, females did not distinguish between the treatment and control sides of the 4-way olfactometer (FIG. 7B). Furthermore, the time spent on the treatment and control sides were not significantly different (FIG. 7C). We, therefore, concluded that acetic acid is not a female attractant. Regardless of the mode of action, the fortuitous discovery that a female-derived sex pheromone ultimately leads to capture of both males and females provides a better tool for monitoring ACP populations.

In conclusion, under laboratory conditions, mating activity in Asian citrus psyllid (ACP) started 4 days after emergence, peaked at day 7, and showed a clear window of activity starting 8 h into the photophase and extending through the first hour of the scotophase. We confirmed that ACP males are attracted to emanations from conspecific females. Traps loaded with a candidate compound enriched with female extract, lignoceryl acetate (24Ac), at various doses were active only after being deployed for several weeks in the field, suggesting that a degradation product, not the test compound, was the active ingredient(s). Lignocerol, a possible product of 24Ac degradation, was not active, whereas acetic acid, another possible degradation product, was found in the airborne volatile collections from lures matured under field conditions and detected in higher amounts in volatiles collected from females at the peak of mating activity than in male samples. Formic acid, acetic acid, and propionic acid elicited dose-dependent electroantennographic responses. In Y-type and 4-way olfactometers, acetic acid attracted ACP males, but not females. Field tests showed that formic, acetic, and propionic acid-baited traps captured significantly more ACP adults than control traps.

### REFERENCES

1 Bove, J. M. Huanglongbing: A destructive, newly-emerging, century-old disease of citrus. J Plant Pathol 88, 7-37 (2006).
2 FUNDECITRUS. United agains greening (in Portuguese), <unidoscontraogreening.com.br> (2017).
3 USDA. CITRUS. October forecast, 2017).
4 da Graca, J. V. et al. Huanglongbing: An overview of a complex pathosystem ravaging the world's citrus. J Integr Plant Biol 58, 373-387, doi:10.1111/jipb.12437 (2016).
5 Setamou, M., Sanchez, A., Saldana, R. R., Patt, J. M. & Summy, R. Visual Responses of Adult Asian Citrus Psyllid (Hemiptera: Liviidae) to Colored Sticky Traps on Citrus Trees. J Insect Behav 27, 540-553 (2014).
6 Bassanezi, R. B. et al. Efficacy of area-wide inoculum eeduction and vector control on temporal progress of Huanglongbing in young sweet orange plantings. Plant Dis 97, 789-796, doi: 10.1094/Pdis-03-12-0314-Re (2013).
7 Suckling, D. M. in Pheromone Communication in Moths: Evolution, Behavior, and Application (eds J. D. Allison & R. T. Carde) 337-347 (University of California Press, 2016).
8 Evenden, M. in Pheromone Communication in Moths: Evolution, Behavior, and Application (eds J. D. Allison & R. T. Carde) 365-393 (University of California Press, 2016).
9 Cork, A. in Pheromone Communication in Moths: Evolution, Behavior, and Application (eds J. D. Allison & R. T. Carde) 349-363 (University of California Press, 2016).
10 Lubanga, U. K., Drijfhout, F. P., Farnier, K. & Steinbauer, M. J. The long and the short of mate attraction in a psylloid: do semiochemicals mediate mating in Aacanthocnema dobsoni Froggatt? Journal of Chemical Ecology 42, 163-172, doi:10.1007/s10886-016-0674-2 (2016).
11 Guedot, C., Horton, D. R. & Landolt, P. J. Attraction of male winterform pear psylla to female-produced volatiles and to female extracts and evidence of male-male repellency. Entomol Exp Appl 30, 191-197, doi:10.1111/j.1570-7458.2008.00807.x (2009).
12 Horton, D. R., Guedot, C. & Landolt, P. J. Attraction to volatiles of male summerform pear psylla from female pear psylla: effects of female age, mating status, and presence of host plant. Can Entomol 140, 184-191 (2008).
13 Wenninger, E. J., Stelinski, L. L. & Hall, D. G. Behavioral evidence for a female-produced sex attractant in Diaphorina citri. Entomol Exp Appl 128, 450-459, doi: 10.1111/j. 1570-7458.2008.00738.x (2008).
14 Mann, R. S. et al. Chemical and behavioral analysis of the cuticular hydrocarbons from Asian citrus psyllid, Diaphorina citri. Insect Sci 20, 367-378, doi: 10.1111/j.1744-7917.2012.01541.x (2013).
15 Wenninger, E. J., Hall, D. G. & Mankin, R. W. Vibrational communication between the sexes in Diaphorina citri (Hemiptera: Psyllidae). Ann Entomol Soc Am 102, 547-555 (2009).
16 Wenninger, E. J., Stelinski, L. L. & Hall, D. G. Relationships between adult abdominal color and reproductive potential in Diaphorina citri (Hemiptera: Psyllidae). Ann Entomol Soc Am 102, 476-483 (2009).
17 Stockton, D. G., Martini, X. & Stelinski, L. L. Male psyllids differentially learn in the context of copulation. Insects 8, doi:10.3390/insects8010016 (2017).
18 Wenninger, E. J. & Hall, D. G. Daily timing of mating and age at reproductive maturity in Diaphorina citri (Hemiptera: Psyllidae). Fla Entomol 90, 715-722, doi:Doi 10.1653/0015-4040(2007)90[715:Dtomaa]2.0. Co; 2 (2007).
19 Hall, D. G., Lapointe, S. L. & Wenninger, E. J. Effects of a particle film on biology and behavior of Diaphorina citri (Hemiptera: Psyllidae) and its infestations in citrus. J Econ Entomol 100, 847-854 (2007).
20 Setamou, M. et al. Diurnal patterns of flight activity and effects of light on host finding behavior of the Asian Citrus Psyllid. J Insect Behav 25, 264-276, doi: 10.1007/s10905-011-9295-3 (2012).
21 Tomaseto, A. F. et al. Environmental conditions for Diaphorina citri Kuwayama (Hemiptera: Liviidae) take-off. J Appl Entomol, 1-10, doi: 10.1111/jen. 12418 (2017).
22 Guerin, P. M. et al. Sex pheromone of Sparganothis pilleriana: E- and Z-11-tetradecenyl acetates as essential components. Entomol. Exp. Appl. 40, 137-140 (1986).
23 Hall, D. G. An assessment of yellow sticky card traps as indicators of the abundance of adult Diaphorina citri (Hemiptera: Psyllidae) in citrus. Journal of Economic Entomology 102, 446-452 (2009).
24 Miranda, M. P. et al. Monitoring methods for Diaphorina citri Kuwayama (Hemiptera: Liviidae) on citrus groves with different insecticide application programmes. J Appl Entomol. 00, 1-8 (2017).
25 Aubert, B. & Quilici, S. in 10th Conference of International Organization of Citrus Virologists. (eds S. M. Garnsey, L. W. Trimmer, & J. A. Dodds) 249-254 (University of California).
26 George, J., Robbins, P. S., Alessandro, R. T., Stelinski, L. L. & Lapointe, S. L. Formic and acetic acids in degradation products of plant volatiles elicit olfactory and behavioral responses from an insect vector. Chem Senses 41, 325-338, doi:10.1093/chemse/bjw005 (2016).
27 Lapointe, S. L., Hall, D. G. & George, J. A phagostimulant blend for the Asian Citrus Psyllid. J Chem Ecol 42, 941-951, doi: 10.1007/s10886-016-0745-4 (2016).
28 Coutinho-Abreu, I. V., McInally, S., Forster, L., Luck, R. & Ray, A. Odor coding in a disease-transmitting herbivorous insect, the Asian citrus psyllid. Chem Senses 39, 539-549, doi: 10.1093/chemse/bju023 (2014).
29 Vet, L. E. M., van Lenteren, J. C., Heymans, M. & Meelis, E. An air-flow olfactometer for measuring olfactory responses of hymenopterous parasitoids and other small insects. Physiol Entomol 8, 97-106, doi:DOI 10.1111/j. 1365-3032.1983.tb00338.x (1983).
30 Carde, R. T. Defining attraction and aggregation pheromones: teleological versus functional perspectives. J Chem Ecol 40, 519-520, doi: 10.1007/s10886-014-0465-6 (2014).
31 Rohde, B., Paris, T. M., Heatherington, E. M., Hall, D. G. & Mankin, R. W. Responses of Diaphorina citri (Hemiptera: Psyllidae) to conspecific vibrational signals and synthetic mimics. Ann Entomol Soc Am 106, 392-399, doi: 10.1603/An12150 (2013).
32 Mankin, R. W. et al. Diaphorina citri (Hemiptera: Liviidae) responses to microcontroller-buzzer communication signals of potential use in vibration traps. Fla Entomol 96, 1546-1555 (2013).
33 Lujo, S. et al. Disrupting mating behavior of Diaphorina citri (Liviidae). Journal of Economic Entomology 109, 2373-2379, doi: 10.1093/jee/tow202 (2016).
34 McGuirte, R. G. Reporting objective colour measurements. HortScience 27, 1254-1255 (1992).

What is claimed is:

1. An insect lure trap comprising a pheromone composition comprising one or more C1-C5 carboxylic acid compounds.

2. The insect lure trap of claim 1, wherein the one or more C1-C5 carboxylic acid compounds is selected from the group consisting of formic acid, acetic acid, propionic acid, and mixtures thereof.

3. The insect lure trap of claim 1, further comprising at least one insecticide.

4. A method for attracting an insect pest, comprising:
placing at a target locus an insect lure trap comprising a pheromone composition comprising one or more C1-C5 carboxylic acid compounds, wherein the target locus is in effective proximity to the insect pest, thereby attracting the insect pest to the insect lure trap.

5. The method of claim 4, wherein the one or more C1-C5 carboxylic acid compounds is selected from the group consisting of formic acid, acetic acid, propionic acid, and mixtures thereof.

6. The method of claim 4, wherein the insect trap further comprises at least one insecticide.

7. The method of claim 6, further comprising bringing into contact the insect pest with the at least one insecticide of the insect trap, thereby killing the insect pest.

8. The method of claim 4, wherein the insect pest is a citrus psyllid.

9. The method of claim 8, wherein the citrus psyllid is an Asian citrus psyllid.

10. The method of claim 8, wherein the citrus psyllid is an African citrus psyllid.

11. A pheromone dispenser for disrupting mating of an insect pest comprising a pheromone composition comprising one or more C1-C5 carboxylic acid compounds.

12. The pheromone dispenser of claim 11, wherein the one or more C1-C5 carboxylic acid compounds is selected from the group consisting of formic acid, acetic acid, propionic acid, and mixtures thereof.

13. A method for disrupting mating of an insect pest, comprising:
placing at a target locus a pheromone dispenser comprising a pheromone composition comprising one or more C1-C5 carboxylic acid compounds, wherein the target locus is in effective proximity to the insect pest, thereby disrupting mating of the insect pest.

14. The method of claim 13, wherein the one or more C1-C5 carboxylic acid compounds is selected from the group consisting of formic acid, acetic acid, propionic acid, and mixtures thereof.

15. The method of claim 13, wherein the insect pest is a citrus psyllid.

16. The method of claim 15, wherein the citrus psyllid is an Asian citrus psyllid.

17. The method of claim 15, wherein the citrus psyllid is an African citrus psyllid.
